(19) United States
(12) Patent Application Publication
(10) Pub. No.: US 2022/0206858 A1
(43) Pub. Date: Jun. 30, 2022

(54) METHOD AND APPARATUS FOR RELAYING DIGITAL CERTIFICATE PROCESSING TASK, MEDIUM, AND PROGRAM PRODUCT

(71) Applicant: ANTPOOL TECHNOLOGIES LIMITED, Hong Kong (CN)

(72) Inventor: Jinzhu ZHANG, Beijing (CN)

(21) Appl. No.: 17/607,766

(22) PCT Filed: May 30, 2019
(86) PCT No.: PCT/CN2019/089195

§ 371 Date: Oct. 29, 2021

(51) Int. Cl. G06F 9/50

(52) U.S. Cl. CPC G06F 9/5027

(57) ABSTRACT

The present disclosure relates to a method and an apparatus for relaying a digital certificate processing task, a medium, and a program product. The method for relaying the digital certificate processing task includes establishing a first connection with a digital certificate processing apparatus and a second connection with a mining pool, obtaining the digital certificate processing task from a mining pool through the second connection, and assigning the digital certificate processing task to the digital certificate processing apparatus through the first connection.

### TECHNICAL FIELD

The present disclosure generally relates to the digital certificate processing technology field and, more particularly, to a method for relaying a digital certificate processing task, an apparatus for relaying the digital certificate processing task, a computer-readable storage medium, and a computer program product.

### BACKGROUND

In the digital certificate processing technology field, digital certificate processing apparatuses are generally deployed on the site of the apparatuses. The digital certificate processing apparatuses establish one-to-one connections with mining pools. As such, the digital certificate processing apparatuses obtain digital certificate processing tasks from the mining pools through the connections and execute the tasks. However, the connections between the digital certificate processing apparatuses and the mining pools are not flexible and cannot satisfy different needs.

### SUMMARY

The present disclosure aims to solve one of the technical problems in the related technology at least to a certain degree. Thus, first aspect embodiments of the present disclosure provide a method for relaying a digital certificate processing task. In the method, a connection between a digital certificate processing apparatus and a mining pool may be set as needed to meet different needs.

Second aspect embodiments of the present disclosure provide an apparatus for relaying a digital certificate processing task.

Third aspect embodiments of the present disclosure provide an apparatus for relaying a digital certificate processing task.

Fourth aspect embodiments of the present disclosure provide a method for relaying a digital certificate processing task.

Fifth aspect embodiments of the present disclosure provide a digital certificate processing apparatus.

Sixth aspect embodiments of the present disclosure provide a digital certificate processing apparatus.

Seventh aspect embodiments of the present disclosure provide a computer-readable storage medium.

Eighth aspect embodiments of the present disclosure provide a computer program product.

To solve the above-mentioned problems, the method for relaying the digital certificate processing task provided by first aspect embodiments of the present disclosure includes establishing a first connection with the digital certificate processing apparatus and a second connection with a mining pool, obtaining a digital certificate processing task from the mining pool through the second connection, and assigning the digital certificate processing task to the digital certificate processing apparatus through the first connection.

According to the method for relaying the digital certificate processing task according to embodiments of the present disclosure, by establishing the first connection with the digital certification processing apparatus and the second connection with the mining pool, the digital certificate processing task may be obtained through the first connection and the second connection. That is, the connection between the digital certificate processing apparatus and the mining pool may be realized through the relay connection. The relay connection may be established as needed. Thus, the connection between the digital certificate processing apparatus and the mining pool is more flexible and can satisfy different needs.

In some embodiments, establishing the first connection with the digital certificate processing apparatus and the second connection with the mining pool includes establishing a plurality of first connections with a plurality of digital certificate processing apparatuses, respectively, and second connections with one of the mining pools. A number of the second connections is less than a number of the first connections, which can reduce a bandwidth requirement of the network connection and save the bandwidth.

In some embodiments, before assigning the digital certificate processing task to the digital certificate processing apparatus through the first connection, the method further includes identifying a content and a difficulty level of the digital certificate processing task according to computation power of each digital certificate processing apparatus.

In some embodiments, the method further includes determining the computation power of each digital certificate processing apparatus according to a theoretical difficulty level of the digital certificate processing task assigned to each digital certificate processing apparatus and a time interval for receiving an answer to a corresponding task.

In some embodiments, establishing the first connection with the digital certificate processing apparatus and the second connection with the mining pool includes establishing the first connection with one of the digital certificate processing apparatuses and the second connections with the plurality of mining pools according to the computation power of the digital certificate processing apparatus. The number of the second connections is greater than the number of the first connections, which may increase the utilization rate of the digital certificate processing apparatus.

To solve the above problems, the device for relaying the digital certificate processing task of second aspect embodiments of the present disclosure includes a connection module configured to establish a first connection with a digital certificate processing apparatus and a second connection with a mining pool, an acquisition module configured to obtain the digital certificate processing task from the mining pool through the second connection, and an assignment module configured to assign the digital certificate processing task to the digital certificate processing apparatus through the first connection.

According to the device for relaying the digital certificate processing task of embodiments of the present disclosure, the first connection is established with the digital certificate processing apparatus through the connection module, and the second connection is established with the mining pool. That is, the connection between the digital certificate processing apparatus and the mining pool may be realized through the relay connection of the connection module, which may make the connection between the digital certificate processing apparatus and the mining pool more flexible to meet different needs.

In some embodiments, when establishing a connection, the connection module is further configured to establish a plurality of first connections with a plurality of digital certificate processing apparatuses, respectively, and establish the second connection with one of the mining pools. The number of the second connections is less than the number of the first connections, which can reduce the requirement on the bandwidth of the network connection and save the bandwidth.

In some embodiments, the apparatus further includes a division module configured to divide the content and the difficulty level of the digital certificate processing task according to the computation power of each digital certificate processing apparatus.

In some embodiments, the device further includes a determination module configured to determine the computation power of each of the digital certificate processing apparatuses according to the theoretical difficulty level of the digital certificate processing task assigned to each of digital certificate processing apparatuses and the time interval for receiving the answer to the corresponding task.

In some embodiments, when establishing a connection, the connection module is further configured to establish the first connection with one of the digital certificate processing apparatuses and establish second connections with a plurality of mining pools according to the computation power of the digital certificate processing apparatuses. The number of the second connections is greater than the number of the first connections, which may increase the utilization rate of the digital certificate processing apparatuses.

In some embodiments, the apparatus includes one of a digital certificate processing analog apparatus and a cloud server.

To solve the above problems, the apparatus for relaying the digital certificate processing task of third aspect embodiments of the present disclosure includes at least one processor and a memory communicatively connected to the at least one processor. The memory stores an instruction executable by the at least one processor that, when the instruction is executed by the at least one processor, causes the at least one processor to execute the method for relaying the digital certificate processing task described in the above embodiments.

To solve the above-mentioned problems, the method for relaying the digital certificate processing task of fourth aspect embodiments of the present disclosure includes establishing a first connection with an apparatus for relaying the digital certificate processing task, receiving the digital certificate processing task obtained from the mining pool by the apparatus for relaying the digital certificate processing task through the first connection, and executing the digital certificate processing task.

According to the method for relaying the digital certificate processing task of embodiments of the present disclosure, the digital certificate processing task is obtained through the relay connection. The relay connection can be established as needed. Thus, the connection between the digital certificate processing apparatus and the mining pool may be more flexible to meet different needs.

To solve the above problems, the digital certificate processing apparatus of fifth aspect embodiments of the present disclosure includes an establishment module configured to establish the first connection with the apparatus that obtains the digital certificate processing task, an acquisition module configured to receive the digital certificate processing task from the mining pool through the apparatus that receives the digital certificate processing task via the first connection, and an execution module configured to execute the digital certificate processing task.

According to the digital certificate processing apparatus of embodiments of the present disclosure, the digital certificate processing task is obtained by establishing the relay connection with the apparatus for relaying the digital certificate processing task. The relay connection can be established as needed. Thus, the connection between the digital certificate processing apparatus and the mining pool may be more flexible to meet different needs.

To solve the above-mentioned problems, the digital certificate processing apparatus of sixth aspect embodiments of the present disclosure includes at least one processor and a memory communicatively connected to the at least one processor. The memory stores an instruction executable by the at least one processor that, when the instruction is executed by the at least one processor, causes the at least one processor to execute the method for relaying the digital certificate processing task described in the above embodiments.

Seventh aspect embodiments of the present disclosure also provide a computer-readable storage medium storing computer-executable instructions. The computer-executable instruction may be programmed to execute the method for relaying the digital certificate processing task described in the above embodiments.

Eighth aspect embodiments of the present disclosure also provide a computer program product. The computer program product includes a computer program stored on a computer-readable storage medium. The computer program includes program instructions that, when the program instructions are executed by a computer, causes the computer to execute the method for relaying the digital certificate processing task described in the above embodiments.

### BRIEF DESCRIPTION OF THE DRAWINGS

One or more embodiments are exemplarily described by the accompanying drawings. These exemplary descriptions and the accompanying drawings do not constitute a limitation on embodiments of the present disclosure. Elements with same reference numerals in the accompanying drawings are shown as similar elements. The accompanying drawings do not constitute a ratio limitation, and among them:

FIG. 1 is a schematic flowchart of a method for relaying a digital certificate processing task according to first aspect embodiments of the present disclosure;

FIG. 2 is a schematic block diagram of an apparatus for relaying a digital certificate processing task according to second aspect embodiments of the present disclosure;

FIG. 3 is a schematic block diagram of an apparatus for relaying a digital certificate processing task according to some other second aspect embodiments of the present disclosure;

FIG. 4 is a schematic block diagram of an apparatus for relaying a digital certificate processing task according to third aspect embodiments of the present disclosure;

FIG. 5 is a schematic block diagram of an apparatus for relaying a digital certificate processing task according to third aspect embodiments of the present disclosure;

FIG. 6 is a schematic flowchart of a method for relaying a digital certificate processing task according to fourth aspect embodiments of the present disclosure;

FIG. 7 is a schematic block diagram of a digital certificate processing apparatus according to fifth aspect embodiments of the present disclosure; and

FIG. 8 is a schematic block diagram of a digital certificate processing apparatus according to sixth aspect embodiments of the present disclosure.

### DETAILED DESCRIPTION OF EMBODIMENTS

To understand the features and technical content of embodiments of the present disclosure with more details, implementation of embodiments of the present disclosure is described in detail below in connection with the accompanying drawings. The accompanying drawings are for reference only and are not used to limit embodiments of the present disclosure. In the following technical description, to facilitate explanation, a number of details are used to provide a sufficient understanding of the disclosed embodiments. However, without these details, one or more embodiments can still be implemented. In other cases, well-known structures and devices may be simplified for a demonstration to simplify the accompanying drawings.

With reference to the accompanying drawings, a method for relaying a digital certificate processing task is described below according to first aspect embodiments of the present disclosure.

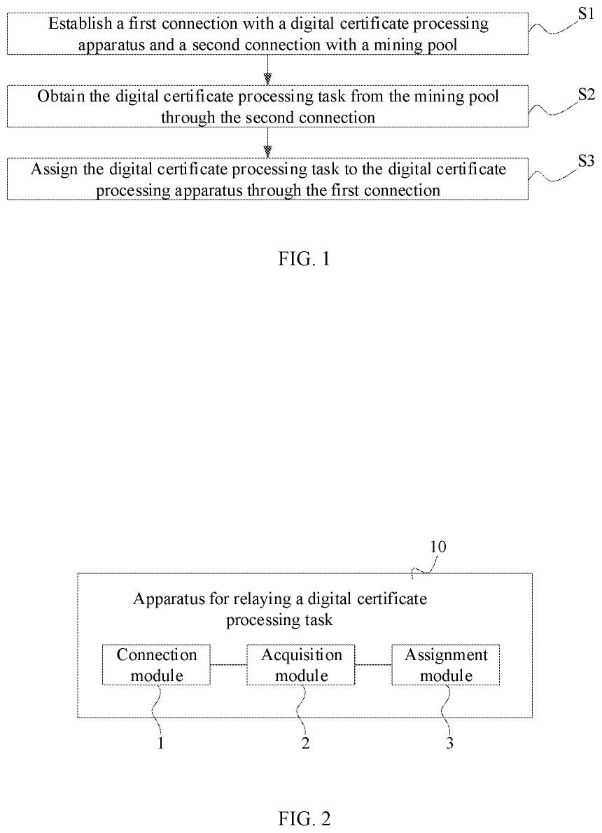

FIG. 1 is a schematic flowchart of a method for relaying a digital certificate processing task according to first aspect embodiments of the present disclosure. As shown in FIG. 1, the method of embodiments of the present disclosure includes step S1, step S2, and step S3.

At step S1, a first connection with a digital certificate processing apparatus and a second connection with a mining pool are established.

In embodiments of the present disclosure, a relay connection mechanism may be added between the digital certificate processing apparatus and the mining pool. The connection between the digital certificate processing apparatus and the mining pool may be realized through the relay connection mechanism. Specifically, a relay connection may be established through one of a digital certificate processing analog apparatus and a cloud server. For example, the cloud server may establish connections with the digital certificate processing apparatus and the mining pool, respectively. The digital certificate processing analog apparatus may have a function similar to the digital certificate processing apparatus, that is, obtaining a digital certificate processing task from the mining pool. In addition, the digital certificate processing analog apparatus may also have a function of assigning a task.

In some embodiments, the first connection and the second connection may be established as needed. For example, the first connection may be established with one or more digital certificate processing apparatuses, and the second connection may be established with one or more mining pools. Through the relay connection, the connection between the digital certificate processing apparatus and the mining pool may be more flexible to meet different needs.

At step S2, the digital certificate processing task is obtained from the mining pool through the second connection.

At step S3, the digital certificate processing task is assigned to the digital certificate processing apparatus through the first connection.

For example, the cloud server may establish the first connection with the digital certificate processing apparatus and the second connection with the mining pool, obtain the digital certificate processing task from the mining pool, and assign the obtained digital certificate processing task to the digital certificate processing apparatus that is connected to the cloud server. Thus, the digital certificate processing apparatus can execute the corresponding digital certificate processing task, so as to realize the acquisition of the digital certificate processing task.

According to the method for relaying the digital certificate processing task of embodiments of the present disclosure, the first connection may be established with the digital certificate processing apparatus, the second connection may be established with the mining pool, and the digital certificate processing task may be obtained through the first connection and the second connection. That is, through the relay connection, the connection between the digital certificate processing apparatus and the mining pool may be realized. The relay connection may be established as needed. Thus, the connection between the digital certificate processing apparatus and the mining pool may be more flexible to meet different needs.

In some cases, the digital certificate processing apparatuses may be deployed at the digital certificate processing apparatus site. The digital certificate processing apparatus may establish a one-to-one connection with the mining pool, obtain tasks from the mining pool connected to the digital certificate processing apparatus, and executes the task. Since different digital certificate processing apparatus need to establish different connections to the mining pools, if a large number of digital certificate processing apparatuses are deployed on the apparatus site, a large number of connections may need to be established, which imposes a high requirement on network bandwidth. The large number of connections may likely cause the network to be instable. Network instability may cause the digital certificate processing apparatus unable to maintain an efficient operation, and even affect the stability of the mining pool.

For the problems above and the case with a plurality of digital certificate processing apparatuses connected to the mining pools, in embodiments of the present disclosure, a plurality of first connections may be established with the plurality of digital certificate processing apparatuses, and a second connection may be established with a mining pool. The number of the second connections may be smaller than the number of first connections. That is, compared to N connections established between N digital certificate processing apparatuses and the mining pool, N is a natural number through the relay connection, the number of network connections between the digital certificate processing apparatuses and the mining pool may be reduced. The digital certificate processing task may be obtained by maintaining fewer connections between the digital certificate processing apparatuses and the mining pool. Thus, the bandwidth may be saved, the demand for the bandwidth of the network connections may be reduced. That is, even if the network stability is poor, the digital certificate processing apparatuses may be ensured to operate effectively.

For example, if fifty digital certificate processing apparatuses are deployed on the apparatus site, and the cloud server may establish the first connections with the fifty digital certificate processing apparatuses, respectively. The number of the first connections is fifty. The cloud server may establish the second connections with the mining pools. The number of the second connections may be twenty or ten or less. The cloud server may obtain the digital certificate processing tasks from the mining pools through the second connections and assign the digital certificate processing tasks to the digital certificate processing apparatuses through the first connections. Through the relay connection of the cloud server, fewer network connections may be required between the digital certificate processing apparatuses and the mining pools to obtain the digital certificate processing tasks and ensure the digital certificate processing apparatuses operate effectively. Thus, the bandwidth requirements for external networks may be reduced, and the bandwidth may be saved.

Further, in some embodiments, before the digital certificate processing task is assigned to the digital certificate processing apparatuses, the content and the difficulty level of the digital certificate processing task may be divided according to the computation power of each digital certificate processing apparatus. The content and the difficulty level of the digital certificate processing task may be divided to be compliant with the requirement of the computation power of the digital certificate processing apparatus. Then, the adjusted digital certificate processing task may be assigned to a corresponding digital certificate processing apparatus. The digital certificate processing apparatus may execute the received tasks.

For example, in the method of embodiments of the present disclosure, the digital certificate processing apparatuses may be managed through the relay connection mechanism. The digital certificate processing analog apparatus may be taken as an example to realize the relay connection. Specifically, the digital certificate processing analog apparatus may establish the second connection with the mining pool by simulating the digital certificate processing apparatus and obtain the digital certificate processing task from the mining pool. The digital certificate processing apparatus on the apparatus site may be connected to the digital certificate processing analog apparatus and obtain the digital certificate processing task from the digital certificate processing analog apparatus. The digital certificate processing analog apparatus may assign the digital certificate processing tasks obtained from the mining pools to different digital certificate processing apparatuses and identify the content and the difficulty level of the digital certificate processing tasks. Thus, different digital certificate processing apparatuses may not perform repeated computations and may maintain an efficient operation.

Specifically, after obtaining the digital certificate processing task from the mining pool, the apparatus for relaying the digital certificate processing task may divide the digital certificate processing task into tasks of a lower difficulty level and assign the tasks to the digital certificate processing apparatuses. To divide the digital certificate processing task into the digital certificate processing tasks of a suitable difficulty level, in some embodiments, the computation power of each digital certificate processing apparatus may be determined according to the theoretical difficulty level of the digital certificate processing task assigned to each digital certificate processing apparatus and the time interval for receiving the answer to the corresponding task. The apparatus for relaying the digital certificate processing task may divide the difficulty level of the digital certificate processing task according to the computation power of each digital certificate processing apparatus and assign the task after the difficulty level is divided to the corresponding digital certificate processing apparatus to maintain the efficient operation.

The theoretical difficulty level of the digital certificate processing task may be determined according to the rated computation power of the digital certificate processing apparatus. For example, ten 10T digital certificate processing apparatuses may be connected to the same mining pool through the apparatus for relaying the digital certificate tasks and have the computation power of 100T for the mining pool. The theoretical difficulty level of the task issued by the mining pool may be the difficulty level of the 100T digital certificate processing apparatuses. When the apparatus for relaying the digital certificate task receives the task, the apparatus for relaying the digital certificate task will divide the task into the difficulty level required by the 10T digital certificate processing apparatus and assign the divided tasks to the ten digital certificate processing apparatuses. If the computation power of a certain digital certificate processing apparatus suddenly drops to 5T due to a certain reason, for example, a failure of a computation power board, the time for the digital certificate processing apparatus to compute the 10T task may increase accordingly. When receiving the change, the apparatus for relaying the digital certificate tasks may adjust the difficulty level of the subsequent assigned digital certificate processing task accordingly for the digital certificate processing apparatus. For example, the apparatus for relaying the digital certificate tasks may only assign the content of 5T difficulty level to the digital certificate processing apparatus.

In short, in the method of embodiments of the present disclosure, through the relay connection, for example, the relay connection apparatuses, such as the digital certificate processing analog apparatus or the cloud server, may be deployed to the internal network of the apparatus site. Thus, only a small amount of the connections with the mining pool may be required to ensure the digital the efficient operation of the digital certificate processing apparatuses, lower the requirements for the network bandwidth, save the bandwidth, and improve the operation stability of the digital certificate processing apparatus.

In other cases, the digital certificate processing apparatus may obtain the digital certificate processing task from the mining pool and then executes the digital certificate processing task. Generally, the digital certificate processing apparatus may only interact with one mining pool. The digital certificate processing apparatus may establish a long connection with the mining pool, continuously obtain the digital certificate task from the mining pool through the long connection, and execute the task. However, the digital certificate processing apparatus may obtain a digital certificate processing task from a mining pool for one user to use. If the computation power requirement of the user is low, the utilization rate of the digital certificate processing apparatus may be low. The rated computation power of the digital certificate processing apparatus may be fixed and unable to meet the user needs of the flexible computation power.

For the above-mentioned problems, the method of embodiments of the present disclosure includes establishing the first connection with a digital certificate processing apparatus based on establishing the relay connection and establishing the second connection with the plurality of mining pools according to the computation power of the digital certificate processing apparatus. The number of the second connections may be greater than the number of the first connections. That is, the digital certificate processing apparatus may obtain the digital certificate processing tasks from the plurality of mining pools and assign different digital certificate processing tasks to the digital certificate processing apparatus. It is equivalent to divide the computation power of the digital certificate processing apparatus into a plurality of small granularities for use by different users to improve the utilization rate of the digital certificate processing apparatus.

Specifically, the cloud server may be taken as an example to realize the relay connection. The cloud server may establish connections with the plurality of mining pools and a digital certificate processing apparatus according to a communication protocol between the mining pools and the digital certificate processing apparatus. That is, one digital certificate processing apparatus may be connected to the plurality of mining pools. The cloud server may be connected to different mining pools according to the user needs, obtain the digital certificate processing tasks from different mining pools, and issue different digital certificate processing tasks to the digital certificate processing apparatus after re-arranging the tasks according to different user needs. The digital certificate processing apparatus may perform corresponding tasks, which is equivalent to divide the computation power of the digital certificate processing apparatus into a plurality of small granularities, such that the digital certificate processing apparatus may be used by different users. Thus, the utilization rate of the digital certificate processing apparatus may be increased, and the digital certificate processing apparatus may meet the user needs of the flexible computation power.

In general, the method for relaying the digital certificate processing tasks of embodiments of the present disclosure includes establishing the first connection with the digital certificate processing apparatus and the second connection with the mining pool. That is, the digital certificate processing tasks may be obtained through the relay connection. As such, the number of connections to the mining pool may be reduced, and the required bandwidth of the connection network may be saved. Moreover, the digital certificate processing apparatus may be connected to the plurality of mining pools to obtain different digital certificate processing tasks, which is equivalent to dividing the computation power of the digital certificate processing apparatus into the plurality of small granularities for use by different users. As such, the utilization rate of the digital certificate processing apparatus may be increased to meet different needs of the user.

The apparatus for relaying the digital certificate processing tasks according to second aspect embodiments of the present disclosure is described below with reference to the accompanying drawings.

FIG. 2 is a schematic block diagram of an apparatus 10 for relaying a digital certificate processing task according to second aspect embodiments of the present disclosure. As shown in FIG. 2, the apparatus 10 for relaying the digital certificate processing task of embodiments of the present disclosure includes a connection module 1, an acquisition module 2, and an assignment module 3.

The connection module 1 may be configured to establish the first connection with the digital certificate processing apparatus and the second connection with the mining pool. The acquisition module 2 may be configured to obtain the digital certificate processing task from the mining pool through the second connection. The assignment module 3 may be configured to assign the digital certificate processing task to the digital certificate processing apparatus through the first connection.

In some embodiments, the first connection and the second connection may be established as needed. For example, the first connection may be established with one or more digital certificate processing apparatuses, and the second connection may be established with one or more mining pools. Through relay connection, the connection between the digital certificate processing apparatus and the mining pool may be more flexible to meet different needs.

In some embodiments, the apparatus 10 for relaying the digital certificate processing tasks may include one of a digital certificate processing analog apparatus and a cloud server, which is equivalent to adding a relay connection apparatus between the digital certificate processing apparatus and the mining pool. The digital certificate processing task may be obtained through the relay connection mechanism. For example, the cloud server may establish the connections with the digital certificate processing apparatus and the mining pool, obtain the digital certificate processing tasks from the mining pool, and assign the obtained digital certificate processing tasks to the digital certificate processing apparatus that is connected to the cloud server. Thus, the digital certificate processing apparatus may perform the corresponding digital certificate processing task to realize the acquisition of the digital certificate processing task.

According to the apparatus 10 for relaying the digital certificate processing tasks of embodiments of the present disclosure, the connection module 1 may be configured to establish the first connection with the digital certificate processing apparatus and the second connection with the mining pool. That is, the digital certificate processing apparatus may be connected to the mining pool through the relay connection of the connection module 1. Thus, the connection between the digital certificate processing apparatus and the mining pool may be more flexible to meet different needs.

In some embodiments, when the plurality of digital certificate processing apparatuses are connected to the mining pool, the connection module 1 may be further configured to establish a plurality of first connections with the plurality of digital certificate apparatuses and the second connection with one mining pool when establishing the connections. The number of the second connection may be less than the number of the first connections. That is, compared to N connections established between N digital certificate processing apparatuses and the mining pool, N being a natural number through the relay connection, the number of the network connections between the digital certificate processing apparatuses and the mining pool may be reduced, and the requirement for the bandwidth of the network connections may be lowered. As such, the bandwidth may be saved. That is, even the stability of the network is poor, the digital certificate processing apparatuses may be ensured to operate efficiently.

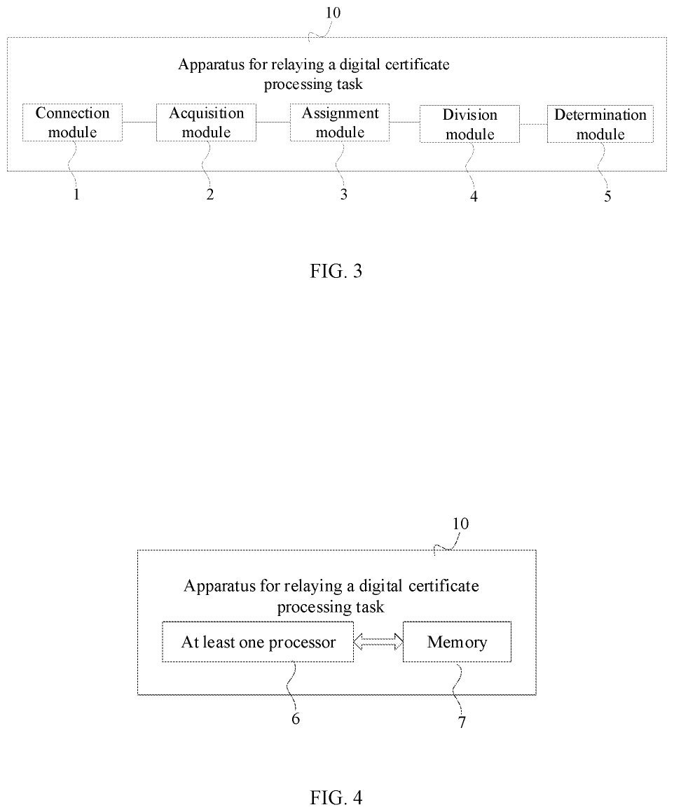

Further, in some embodiments, as shown in FIG. 3, the apparatus 10 for relaying the digital certificate processing tasks further includes a division module 4. The division module 4 may be configured to divide the content and the difficulty level of the digital certificate processing task according to the computation power of each digital certificate processing apparatus. The content and the difficulty level of the digital certificate processing task may be divided to be compliant with the requirement of the computation power of the digital certificate processing apparatus. Then, the assignment module 3 may be configured to distribute the digital certificate processing task after the difficulty level is divided into the corresponding digital certificate processing apparatus. The digital certificate processing apparatus may perform the received task.

As shown in FIG. 3, the apparatus 10 for relaying the digital certificate processing tasks further includes a determination module 5. The determination module 5 may be configured to determine, according to the theoretical difficulty level of the digital certificate processing task assigned to each digital certificate processing apparatus and the time interval of receiving the answer to the corresponding task, the computation power of each digital certificate processing apparatus. Then, the division module 4 may be configured to divide the content and the difficulty level of the digital certificate processing task according to the computation power of each digital certificate processing apparatus. The assignment module 3 may be configured to assign the task after the difficulty level is divided to the corresponding digital certificate processing apparatus to ensure to process the task more efficiently.

In some other embodiments, the digital certificate processing apparatus can only be connected to one mining pool. Thus, the utilization rate of the digital certificate processing apparatus may be low. The connection module 1 may be further configured to establish the first connection with one digital certificate processing apparatus and the second connections with the plurality of mining pools according to the computation power of the digital certificate processing apparatus when establishing the connection. The number of the second connections may be greater than the number of the first connections. That is, the digital certificate processing apparatus may be connected to the plurality of mining pools through the apparatus 10 for relaying the digital certificate processing task to obtain the digital certificate processing tasks from different mining pools. It is equivalent to dividing the computation power of the digital certificate processing apparatus into the plurality of small granularities, such that the digital certificate processing apparatus can be used by different users. The utilization rate of digital certificate processing apparatus may be improved, and the digital certificate processing apparatus may meet the user requirement of the flexible computation power.

In summary, with the apparatus 10 for relaying the digital certificate processing tasks of embodiments of the present disclosure, the number of the connections with the mining pools may be reduced, and the required bandwidth of the connection network may be saved. The digital certificate processing apparatus may be also connected to the plurality of mining pools, which improves the utilization rate of the digital certificate processing apparatus to meet different user needs.

The apparatus for relaying the digital certificate processing tasks of third aspect embodiments of the present disclosure is described below with reference to the accompanying drawings. As shown in FIG. 4, the apparatus 10 for relaying the digital certificate processing tasks of embodiments of the present disclosure includes at least one processor 6 and a memory 7 communicatively connected to the at least one processor 6. The memory 7 may store an instruction that is executable by the at least one processor 6 that, when the instruction is executed by the at least one processor 6, causes the at least one processor 6 to execute the method for relaying the digital certificate processing tasks of the above embodiments.

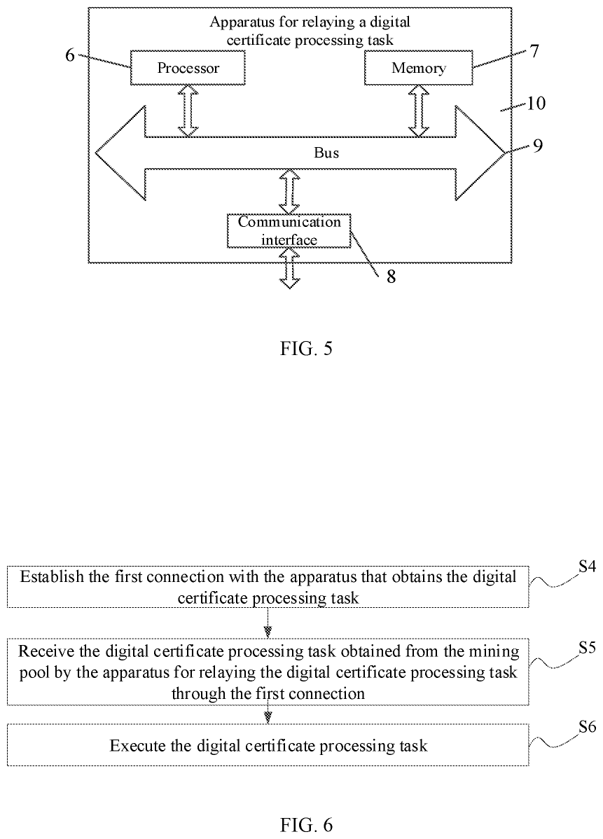

As shown in FIG. 5, one processor 6 is taken as an example. The apparatus for relaying the digital certificate processing tasks further includes a memory 7, a communication interface 8, and a bus 9. The processor 6, the communication interface 8, and the memory 7 may communicate with each other through the bus 9. The communication interface 8 may be configured to transmit information. The processor 6 may call logic instructions in the memory 7 to execute the method for relaying digital certificate processing tasks in the above embodiments.

In addition, the logic instruction of the memory 7 may be realized through a form of a software functional unit and may be sold or applied as an individual product. The logic instruction 7 may be stored in the computer-readable storage medium.

As a computer-readable storage medium, the memory 7 may be configured to store software programs and computer-executable programs, such as program instructions/modules corresponding to the methods of embodiments of the present disclosure. The processor 6 may execute functional applications and data processing by running the software programs, instructions, and modules stored in the memory 7. That is, the method for relaying the digital certificate processing tasks of the above method embodiments may be implemented.

The memory 7 may include a program storage area and a data storage area. The program storage area may store an operating system and an application program required by at least one function. The data storage area may store data created according to the use of the terminal apparatus. In addition, the memory 7 may further include a high-speed random access memory and a non-volatile memory.

The method for relaying the digital certificate processing task according to fourth aspect embodiments of the present disclosure is described with reference to the accompanying drawings.

FIG. 6 is a schematic flowchart of a method for relaying a digital certificate processing task according to fourth aspect embodiments of the present disclosure. As shown in FIG. 6, the method of the present disclosure includes step S4, step S5, and step S6.

At step S4, the first connection is established with the apparatus that obtains the digital certificate processing task.

At step S5, the digital certificate processing task obtained from the mining pool by the apparatus for relaying the digital certificate processing task is received through the first connection.

At step S6, the digital certificate processing task is executed.

In some embodiments, the apparatus for relaying the digital certificate processing tasks may include the apparatus that realizes the relay connection between the digital certificate processing apparatus and the mining pool. In some embodiments, the apparatus for relaying the digital certificate processing tasks may include the digital certificate processing analog apparatus or the cloud server. For example, the digital certificate processing analog apparatus or the cloud server may simulate the digital certificate processing apparatus to establish the first connection with the digital certificate processing apparatus and the second connection with the mining pool. The digital certificate processing analogy apparatus or the cloud server may obtain the digital certificate processing tasks from the mining pool and assign the digital certificate processing tasks to the digital certificate processing apparatuses through the first connection.

The first connection and the second connection may be established as needed. For example, the apparatus for relaying the digital certificate processing tasks may establish the plurality of first connections with the plurality of digital certificate processing apparatuses and the second connection with one mining pool. The number of the second connections may be smaller than the number of the first connections, which may reduce the bandwidth and lower the requirement of the bandwidth of the network connection. Alternatively, the apparatus for relaying the digital certificate processing tasks may establish the first connection with one digital certificate processing apparatus and the second connections with the plurality of mining pools. Thus, the apparatus for relaying the digital certificate processing tasks may obtain the digital certificate processing tasks from the plurality of mining pools and assign the digital certificate processing tasks to the digital certificate processing apparatus. Thus, the digital certificate processing apparatus may be used by different users to increase the utilization rate of the digital certificate processing apparatus.

According to the method for relaying digital certificate processing tasks according to the embodiment of the present application, the digital certificate processing task is acquired through the relay connection, and the relay connection can be established according to requirements, thereby making the connection between the digital certificate processing device and the mining pool more flexible and meeting different needs.

The digital certificate processing apparatus of fifth aspect embodiments of the present disclosure is described below with reference to the accompanying drawings.

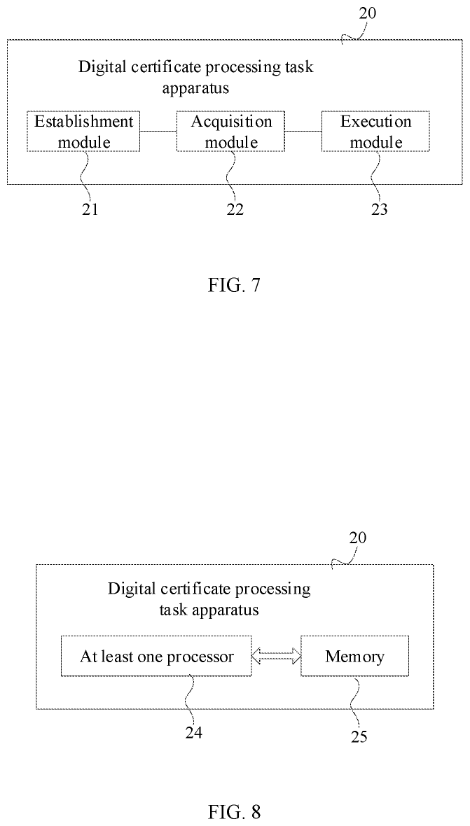

FIG. 7 is a schematic block diagram of a digital certificate processing apparatus 20 according to fifth aspect embodiments of the present disclosure. As shown in FIG. 7, the digital certificate processing apparatus 20 includes an establishment module 21, an acquisition module 22, and an execution module 23.

The establishment module 21 may be configured to establish the first connection with the device for relaying the digital certificate processing task. The acquisition module 22 may be configured to receive the digital certificate processing task obtained from the mining pool by the apparatus for relaying the digital certificate processing task through the first connection. The execution module 23 may be configured to execute the received digital certificate processing task. That is, the apparatus for relaying the digital certificate processing task may establish the connections with the digital certificate processing apparatus 20 and the mining pool, which is equivalent to establishing the relay connection between the digital certificate processing apparatus 20 and the mining pool. The digital certificate processing apparatus may obtain the digital certificate processing task through the relay connection. The relay connection may be established as needed, which is more flexible and meets different needs.

In some embodiment, the apparatus for relaying the digital certificate processing task may include the apparatus that realizes the relay connection between the digital certificate processing apparatus and the mining pool. In some embodiments, the apparatus for relaying the digital certificate processing task may include the digital certificate processing analog apparatus or the cloud server.

In some embodiments, the digital certificate processing apparatus 20 may perform data processing related to the digital certificate. The digital certificate may be obtained through the data processing. Further, when the digital certificate is related to or embodied as encrypted currency, the digital certificate processing apparatus 20 may include a blockchain computation apparatus. The digital currency may be an encrypted currency based on the blockchain technology.

The digital certificate processing apparatus 20 of embodiments of the present disclosure may obtain the digital certificate processing task by establishing the relay connection with the apparatus for relaying the digital certificate processing task. The relay connection may be established as needed. Thus, the connection between the digital certificate processing apparatus and the mining pool may be more flexible to meet different needs.

The digital certificate processing apparatus of sixth aspect embodiments of the present disclosure is described with reference to the accompanying drawings.

FIG. 8 is a schematic block diagram of a digital certificate processing apparatus 20 according to sixth aspect embodiments of the present disclosure. The digital certificate processing apparatus 20 of embodiments of the present disclosure includes at least one processor 24 and a memory 25 communicatively connected to the at least one processor.

The memory 25 may store instructions executable by at least one processor 24 that, when the instructions are executed by the at least one processor 24, causes the at least one processor 24 to execute the method for relaying the digital certificate processing tasks of fifth aspect embodiments.

Seventh aspect embodiments of the present disclosure further provide a computer-readable storage medium that stores computer-executable instructions. The computer-executable instructions may be programmed to execute the method for relaying the digital certificate processing tasks of first aspect embodiments above. Alternatively, the computer-executable instructions may be programmed to execute the method for relaying the digital certificate processing tasks of fourth aspect embodiments above.

Eighth aspect embodiments of the present disclosure further provide a computer program product. The computer program product may include a computer program stored on the computer-readable storage medium. The computer program may include program instructions that, when the program instructions are executed by a computer, causes the computer to execute the above the method for relaying the digital certificate processing task of first aspect embodiments, or the method for relaying the digital certificate processing tasks of fourth aspect embodiments.

The above-mentioned computer-readable storage medium may include a transitory computer-readable storage medium or a non-transitory computer-readable storage medium.

The technical solutions of embodiments of the present disclosure may be embodied in the form of a software product. The computer software product may be stored in a storage medium and includes one or more instructions to enable a computer apparatus (e.g., a personal computer, a server, a network apparatus, etc.) to execute all or some steps of the method described in embodiments of the present disclosure. The above-mentioned storage medium may include a non-transitory storage medium, including a plurality of media that can store the program codes, such as U disk, mobile hard disk, read-only memory (ROM), random access memory (RAM), magnetic disks, or optical disks, etc. The storage medium may also include a transitory storage medium.

When used in the present disclosure, although the terms “first,” “second,” etc. may be used in the present disclosure to describe various elements, these elements should not be limited by these terms. These terms are only used to distinguish one element from another element. For example, without changing the meaning of the description, the first element can be named as the second element, and similarly, the second element can be named as the first element, as long as all the “first elements” are renamed consistently and all occurrences the “second elements” are renamed consistently. The first element and the second element are both elements and may not be the same element.

The terms used in the present disclosure are only used to describe embodiments and are not used to limit the claims. As used in the description of embodiments and the claims, unless the context clearly indicates, the singular forms “a,” “an,” and “the” are intended to also include plural forms. Similarly, the term “and/or” as used in the present disclosure may refer to any and all possible combinations, including one or more of the associated lists. In addition, when used in the present disclosure, the term “comprise” and its variants “comprises” and/or “comprising” may refer to the stated features, wholes, steps, operations, elements, and/or existence of an assembly, but may not exclude the existence or addition of one or more other features, wholes, steps, operations, elements, assemblies, and/or groups thereof.

The various aspects, implementations, realizations, or features in the described embodiments may be used alone or in any combination. Various aspects in the described embodiments may be implemented by software, hardware, or a combination of software and hardware. The described embodiments may also be embodied by a computer-readable medium storing the computer-readable codes. The computer-readable codes may include instructions executable by at least one computation device. The computer-readable medium may be associated with any data storage device capable of storing data. The data may be read by a computer system. The computer-readable medium used as an example may include read-only memory, random access memory, compact disc read-only memory (CD-ROM), hard disk drive (HDD), digital video disc (DVD), magnetic tape, optical data storage device, etc. The computer-readable medium may also be distributed in a computer system connected through the network connection so that the computer-readable codes can be stored and executed in a distributed manner.

The above technical description may refer to the accompanying drawings, which form a part of the present disclosure. Through the description, the accompanying drawings show implementations in accordance with the described embodiments. Although these embodiments are described in sufficient detail to enable those skilled in the art to implement these embodiments, these embodiments are non-limiting. Thus, other embodiments may be modified without departing from the scope of the described embodiments. For example, the sequence of operations described in the flowchart is non-limiting. Thus, the sequence of two or more operations explained in the flowchart and described according to the flowchart can be modified according to several embodiments. For another example, in some embodiments, one or more operations illustrated in the flowchart and described according to the flowchart may be optional or can be deleted. In addition, some steps or functions may be added to embodiments of the present disclosure, or the sequence of two or more steps may be replaced. All these modifications may be considered to be included in the embodiments and the claims of the present disclosure.

In addition, the terminology is used in the above technical description to provide a thorough understanding of the described embodiments. However, too many details may not be required to implement the described embodiments. Therefore, the above description of embodiments may be presented for explanation and description. The embodiments presented in the above description and the examples applied according to these embodiments may be provided separately to add the context and help understand the described embodiments. The above description is not intended to be exhaustive or to limit the described embodiments to the precise form of the present disclosure. According to the above teachings, several modifications, options, and changes may be feasible. In some cases, well-known processing steps are not described in detail to avoid unnecessarily affecting the described embodiments.

1. A method for relaying a digital certificate processing task comprising:
establishing a first connection with a digital certificate processing apparatus and a second connection with a mining pool;
obtaining the digital certificate processing task from the mining pool through the second connection; and
assigning the digital certificate processing task to the digital certificate processing apparatus through the first connection.

2. The method for relaying the digital certificate processing task of claim 1, wherein establishing the first connection with the digital certificate processing apparatus and the second connection with the mining pool includes:
establishing a plurality of first connections with a plurality of digital certificate processing apparatuses, respectively, and second connections with mining pools, a number of the second connections being smaller than a number of the first connections.

3. The method for relaying the digital certificate processing task of claim 1, further comprising, before assigning the digital certificate processing task to the digital certificate processing apparatus through the first connection:
identifying a content and a difficulty level of the digital certificate processing task according to computation capability of each digital certificate processing apparatus.

4. The method for relaying the digital certificate processing task of claim 3, further comprising:
determining the computation capability of each digital certificate processing apparatus according to a theoretical difficulty level of the digital certificate processing task assigned to each digital certificate processing apparatus and a time interval of receiving answers to corresponding tasks.

5. The method for relaying the digital certificate processing task of claim 1, wherein establishing the first connection with the digital certificate processing apparatus and the second connection with the mining pool includes:
establishing the first connection with one digital certificate processing apparatus and second connections with a plurality of mining pools according to the computation capability of the digital certificate processing apparatus, a number of the second connections being greater than a number of the first connection.

6. An apparatus for relaying a digital certificate processing task comprising:
a connection module configured to establish a first connection with a digital certificate processing apparatus and a second connection with a mining pool;
an acquisition module configured to obtain the digital certificate processing task from the mining pool through the second connection; and
an assignment module configured to assign the digital certificate processing task to the digital certificate processing apparatus through the first connection.

7. The apparatus for relaying the digital certificate processing task of claim 6, wherein the connection module is further configured to:
establish a plurality of first connections with a plurality of digital certificate processing apparatuses, respectively, and second connections with mining pools, a number of the second connections being smaller than a number of the first connections.

8. The apparatus for relaying the digital certificate processing task of claim 6, further comprising:
a division module configured to divide a content and a difficulty level of the digital certificate processing task according to computation capability of each digital certificate processing apparatus.

9. The apparatus for relaying the digital certificate processing task of claim 8, further comprising:
a determination module configured to determine the computation capability of each digital certificate processing apparatus according to a theoretical difficulty level of the digital certificate processing task assigned to each digital certificate processing apparatus and a time interval of receiving answers to corresponding tasks.

10. The apparatus for relaying the digital certificate processing task of claim 6, wherein the connection module is further configured to:
establish the first connection with one digital certificate processing apparatus and second connections with a plurality of mining pools according to the computation capability of the digital certificate processing apparatus, a number of the second connections being greater than a number of the first connection.

11. The apparatus for relaying the digital certificate processing task of claim 6 comprising one of a digital certificate processing analog apparatus and a cloud server.

12. An apparatus for relaying a digital certificate processing task comprising:
a processor; and
a memory communicatively connected to the processor storing instructions executable by the processor that, when executed by the processor, causes the processor to:
establish a first connection with a digital certificate processing apparatus and a second connection with a mining pool;
obtain the digital certificate processing task from the mining pool through the second connection; and
assign the digital certificate processing task to the digital certificate processing apparatus through the first connection.

13. (canceled)

14. (canceled)

15. (canceled)

16. (canceled)

17. (canceled)

18. The apparatus for relaying the digital certificate processing task of claim 12, wherein the processor is further caused to:
establish a plurality of first connections with a plurality of digital certificate processing apparatuses, respectively, and second connections with mining pools, a number of the second connections being smaller than a number of the first connections.

19. The apparatus for relaying the digital certificate processing task of claim 12, wherein the processor is further caused to:
identify a content and a difficulty level of the digital certificate processing task according to computation capability of each digital certificate processing apparatus.

20. The apparatus for relaying the digital certificate processing task of claim 19, wherein the processor is further caused to:
determine the computation capability of each digital certificate processing apparatus according to a theoretical difficulty level of the digital certificate processing task assigned to each digital certificate processing apparatus and a time interval of receiving answers to corresponding tasks.

21. The apparatus for relaying the digital certificate processing task of claim 12, wherein the processor is further caused to:
establish the first connection with one digital certificate processing apparatus and second connections with a plurality of mining pools according to the computation capability of the digital certificate processing apparatus, a number of the second connections being greater than a number of the first connection.

22. The apparatus for relaying the digital certificate processing task of claim 12, wherein the apparatus includes one of a digital certificate processing analog apparatus and a cloud server.
